(19) United States
(12) Patent Application Publication
(10) Pub. No.: US 2024/0369007 A1
(43) Pub. Date: Nov. 7, 2024

(54) HEATER CONTROL UNIT FOR EXHAUST AFTER TREATMENT SYSTEM

(71) Applicant: Cummins Inc., Columbus, IN (US)

(72) Inventors: Anand Narayan Jarudkar, Pune (IN); Latif M. Shaikh, Pune (IN); Aman Chaudhari, Pune (IN)

(21) Appl. No.: 18/288,750

(22) PCT Filed: Apr. 28, 2022
(86) PCT No.: PCT/US2022/026755

§ 371 Date: Oct. 27, 2023

(30) Foreign Application Priority Data
Apr. 30, 2021 (IN) 202111019893

(51) Int. Cl. F01N 9/00; F01N 3/20; H05B 1/02

(52) U.S. Cl. CPC F01N 9/00; F01N 3/2013; H05B 1/0202; H05B 1/0236; F01N 2240/16; F01N 2900/0602

(57) ABSTRACT

A heater control unit and wiring harness for coupling a battery to an exhaust after treatment system of an internal combustion engine. The heater control unit is configured with one or more capacitors and diodes to accommodate transient oscillating current flows that may be caused by energy stored in the wiring harness when the heater control unit switches between on and off states.

### FIELD

This disclosure relates generally to heater control units used in connection with exhaust aftertreatment systems for internal combustion engines.

### BACKGROUND

Internal combustion engines, such as for example those powered by diesel fuel, may include exhaust aftertreatment systems to reduce emissions in the engine exhaust. Aftertreatment systems of these types may include auxiliary electric heaters to heat the exhaust during certain engine operating conditions, such as for example during cold starts and low duty cycle conditions. A heater control unit (HCU) may be used to switch the heater on and off by controllably applying power and discontinuing the application of power from a power source, such as a battery, to the heater. Exhaust aftertreatment systems of these type may draw relatively large currents (e.g., up to and greater than 125 amp RMS current), and relatively large amounts of power (e.g., up to and greater than 10 KW).

The heater may be coupled to the HCU and the power source by an electrical wiring harness. For example, the harness may include a first section coupling a first positive or power input HCU terminal to a first or positive battery terminal, a second section coupling a second positive or switched power output HCU terminal to a first or positive heater terminal, a third section coupling a third or negative HCU terminal to a second or negative battery terminal, and a fourth section coupling the negative battery terminal to a second or negative heater terminal. In response to control signals causing the HCU to switch to its on state, the HCU electrically couples its input terminal to its switched power output terminal, thereby coupling the positive battery terminal to the heater and turning the heater on by enabling the application of power to the heater. In response to control signals causing the HCU to switch to its off state, the HCU electrically disconnects its input terminal from the switched power output terminal, thereby turning the heater off by discontinuing the application of power.

The wiring harness sections used to couple the battery, HCU and heater in aftertreatment systems of these types may have relatively high inductances (e.g., between 4 μH and 10 μH). The HCU may be configured to accommodate transient voltage and current oscillations produced by energy stored in the wiring harness sections when the HCU is switched off. For example, the HCU may include capacitors to help accommodate the transient current oscillations.

There remains a continuing need for improved HCUs for use in connection with exhaust aftertreatment systems. For example, there is a need for improved HCUs configured to accommodate the electrical operating characteristics of the inductances associated with the wiring harnesses. HCUs of these types that can be efficiently manufactured would be especially desirable.

### SUMMARY

Disclosed examples include a heater control unit for coupling an exhaust aftertreatment system heater to a power supply. Embodiments may comprise a switch responsive to a control signal and switchable between on and off states, the switch configured to control current flow about a first path between a first wiring harness section coupled to the power supply and a second wiring harness section coupled the heater, wherein the switch enables current flow about the first path when in the on state; one or more capacitors; a first diode coupled in series with the one or more capacitors, the series-coupled first diode and one or more capacitors configured to provide current flow about a second path between the first and second wiring harness sections, wherein when the switch is in the off state the first diode enables current flow about the second path through the one or more capacitors in a first direction, and blocks current flow about the second path through the one or more capacitors in a second direction opposite the first direction; and a second diode coupled in series with the one or more capacitors, the series-connected second diode and one or more capacitors configured to provide current flow about a third path between the first wiring harness section and a third wiring harness section coupled to the power supply, wherein when the switch is in the off state the second diode enables current flow about the third path through the one or more capacitors in the second direction, and blocks current flow about the third path through the one or more capacitors in the first direction.

In embodiments, one or both of the first and second diodes may comprise a MOSFET configured as a diode. In any or all of the above embodiments the one or more capacitors comprises a plurality of capacitors coupled in parallel. In any or all of the above embodiments the switch comprises a plurality of discrete switches responsive to the control signal and coupled in parallel. In any or all of the above embodiments the series-coupled first diode and one or more capacitors are coupled in parallel with the switch, and the first and second paths include parallel paths between the first and second wiring harness sections.

In any or all of the above embodiments the heater control unit may further comprise a wiring harness to couple the heater control unit to the exhaust aftertreatment system heater and power supply, wherein the wiring harness includes: the first wiring harness section to couple the switch (e.g., a first terminal of the switch) and the one or more capacitors (e.g., a terminal of the capacitors opposite the capacitors from the first diode) to a first polarity (e.g., positive) terminal of the power supply; the second wiring harness section to couple the switch (e.g., a second terminal of the switch) and the first diode (e.g., a terminal of the diode opposite the diode from the capacitors) to a first terminal (e.g., positive) of the heater; and the third section to couple the second diode (e.g., a terminal of the diode opposite the diode from the capacitors) to a second polarity (e.g., negative) terminal of the power supply. In embodiments, each of one or more of the first, second and third wiring harness sections is defined by an inductance (e.g., between 1 μH, and 4 μH; between 4 μH, and 9 μH; or greater than 9 μH).

Any or all of the above embodiments may further include the exhaust aftertreatment heater and the power supply coupled to the heater control unit by the first, second and third wiring harness sections. In any or all of the above embodiments the wiring harness further includes a fourth wiring harness section to couple the second polarity terminal of the power supply (e.g., negative) to a second terminal (e.g., negative) of the heater. The fourth wiring harness section may be defined by an inductance (e.g., between 1 μH, and 4 μH; between 4 μH, and 9 μH; or greater than 9 μH).

Another example is a heater control unit for coupling an exhaust aftertreatment system heater to a power supply. Embodiments may comprise: a control input configured to receive a control signal; a first polarity supply terminal configured to be coupled to a first polarity terminal of the power supply; a switched power output terminal configured to be coupled to a first terminal of the heater; a second polarity supply terminal configured to be coupled to a second polarity terminal of the power supply; a switch coupled to the control input and switchable between on and off states, wherein the switch is configured to control current flow about a first path between the first polarity supply terminal and the switched power output terminal, and enables current flow about the first path when in the on state; one or more capacitors; a first diode including an anode and a cathode coupled in series with the one or more capacitors, the series-coupled first diode and one or more capacitors defining a second path including the one or more capacitors between the first polarity supply terminal and the switched power output terminal, wherein when the switch is in the off state the first diode enables current flow about the second path in a first direction through the one or more capacitors, and blocks current flow about the second path in a second direction opposite the first direction through the one or more capacitors; a second diode including an anode and a cathode coupled in series with the one or more capacitors, the series-coupled second diode and one or more capacitors defining a third path including the one or more capacitors between the first polarity supply terminal and the second polarity supply terminal, wherein when the switch is in the off state the second diode enables current flow about the third path in the second direction through the one or more capacitors, and blocks current flow about the third path in the first direction through the one or more capacitors.

In embodiments, the first polarity supply terminal is a positive supply terminal configured to be coupled to a positive terminal of the power supply; the second polarity supply terminal is a negative supply terminal configured to be coupled to a negative terminal of the power supply; the one or more capacitors each include a first terminal coupled to the positive supply terminal, and a second terminal; the first diode includes an anode coupled to the second terminal of each of the one or more capacitors and a cathode coupled to the switched power output terminal; the second diode includes an anode coupled to the negative supply terminal and a cathode coupled to second terminal of each of the one or more capacitors.

In any or all of the above embodiments, one or both of the first and second diodes comprise a MOSFET configured as a diode. In any or all of the above embodiments the one or more capacitors comprise a plurality of capacitors coupled in parallel. In any or all of the above embodiments the switch comprises a plurality of semiconductor switches coupled in parallel. In any or all of the above embodiments the series-coupled first diode and one or more capacitors are coupled in parallel with the switch, and the first and second paths include parallel paths between the first polarity supply terminal and the switched power output terminal.

Embodiments may further comprise a wiring harness to couple the heater control unit to the exhaust aftertreatment system heater and power supply, wherein the wiring harness includes: a first wiring harness section to couple the first polarity supply terminal to a first polarity terminal of the power supply; a second wiring harness section to couple the switched power output terminal to a first terminal of the heater; and a third section to couple the second polarity supply terminal to a second polarity terminal of the power supply. In embodiments each of one or more of the first, second and third wiring harness sections is defined by an inductance (e.g., between 1 μH, and 4 μH; between 4 μH, and 9 μH; or greater than 9 μH).

Embodiments may further include the exhaust aftertreatment heater and the power supply coupled to the heater control unit by the first, second and third wiring harness sections. In embodiments the wiring harness further includes a fourth wiring harness section to couple the second polarity terminal of the power supply to a second terminal of the heater. The fourth wiring harness section may be defined by an inductance (e.g., between 1 μH, and 4 μH; between 4 μH, and 9 μH; or greater than 9 μH).

### BRIEF DESCRIPTION OF THE DRAWINGS

FIG. 1 is a diagrammatic illustration of an engine system including a heater control unit, in accordance with embodiments.

FIG. 2 is a diagrammatic illustration of a heater control unit coupled to a battery and a heater by a wiring harness, in accordance with embodiments.

FIG. 3 is a diagrammatic schematic illustration of an output driver of a heater control unit, in accordance with embodiments.

FIGS. 4A-4C are versions of the diagrammatic schematic illustrations of FIG. 3, illustrating the operation of the heater control unit.

FIGS. 5A and 5B illustrate examples of instantaneous and RMS currents, respectively, in the capacitors of the heater control unit shown in FIGS. 3 and 4A-4C, under certain operating conditions and in accordance with embodiments.

FIG. 6 is a diagrammatic schematic illustration of an output driver of a heater control unit for purposes of describing a comparative example.

FIGS. 7A and 7B illustrate examples of instantaneous and RMS currents, respectively, in the capacitors of the heater control unit shown in FIG. 6 under operating conditions similar to those used in connection with FIGS. 5A and 5B, for purposes of a comparative example, in accordance with embodiments.

### DETAILED DESCRIPTION

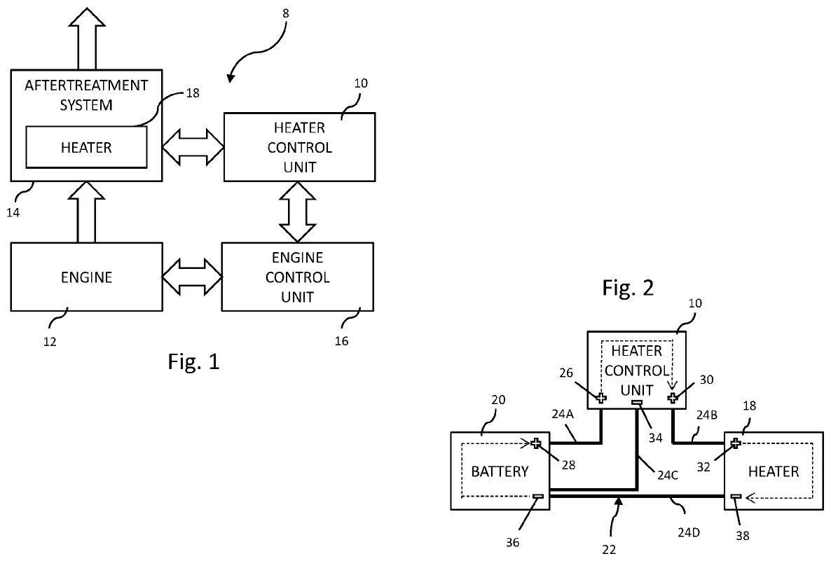

FIG. 1 is a diagrammatic illustration of an exemplary engine system 8 including a heater control unit (HCU) 10 in accordance with embodiments. An engine 12 is coupled to an exhaust aftertreatment system 14, which processes exhaust from the engine to reduce emissions such as particulates and certain types of gasses produced during the operation of the engine. The engine 12, which is a diesel-fueled engine in embodiments, may be controlled by an engine control unit (ECU) 16. As shown, the aftertreatment system 14 includes an auxiliary heater 18 that may be used to heat the exhaust produced by the engine 14. For example, heater 18 may be used to heat the exhaust during cold starts of the engine 12, and/or during low duty cycle conditions. Aftertreatment systems such as 14 and heaters such as 18 are generally known. The heater 18 may controlled by the HCU 10 in response to control signals received from the ECU 16. For example, in response to signals from the ECU 16 to switch the heater 18 and off, HCU 10 can switch between an on state and an off state to couple power to the heater 18, and discontinue the application of power to the heater, respectively.

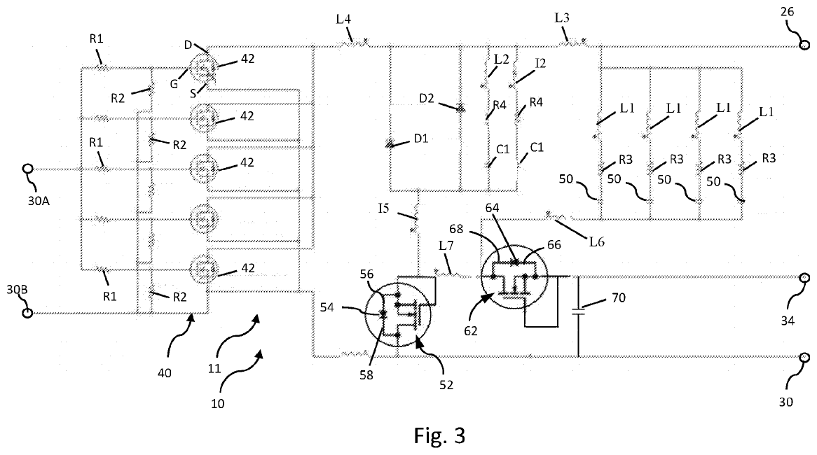

FIG. 2 is a diagrammatic illustration of a power source, such as battery 20, coupled to the HCU 10 and heater 18 by a wiring harness 22. In the illustrated embodiments, the wiring harness 22 includes four sections 24A-24D. First section 24A couples a first positive (e.g., a first polarity) or power input supply terminal 26 of the HCU 10 to a positive (e.g., first polarity) terminal 28 of the battery 20. Second section 24B couples a second positive or switched power output terminal 30 of the HCU 10 to a first or positive terminal 32 of the heater 18. Third section 24C couples a third or negative (e.g., second polarity) terminal 34 of the HCU 10 to a negative (e.g., second polarity) terminal 36 of the battery 20. Fourth section 24D couples a second or negative terminal 38 of the heater 18 to the negative terminal 36 of the battery 20.

HCU 10 controllably couples the battery 20 to the heater 18 to control the flow of power from the battery to the heater. In response to control signals from the ECU 16 to switch the heater 18 on, HCU 10 switches to an on state electrically coupling its power input supply terminal 26 to its switched power output terminal 30, thereby electrically connecting the positive terminal 28 of the battery 20 to the first terminal 32 of the heater. In response to control signals from the ECU 16 to switch the heater 18 off, HCU 10 switches to an off state electrically decoupling its power input supply terminal 26 from the switched power output terminal 30, thereby electrically disconnecting the positive terminal 28 of the battery 20 from the first terminal 32 of the heater.

In embodiments, the heater 18 may draw relatively high amounts of power. In embodiments of systems 8 including a forty-eight volt battery 20, the HCU 10 may, for example, deliver 10 KW or more power to the heater 18. Current levels coupled by the wiring harness 22 and accommodated by the HCU 10 in connection with these power levels may also be relatively high, such as for example up to or exceeding 125 amps. Other embodiments may be characterized by greater or lesser power levels. In embodiments, the HCU 10 may be cyclically switched between its on and off states. As an example, the operating frequency of the HCU may be 500 Hz, although other embodiments may operate at lesser or greater frequencies. The wiring harness sections 24A-24C may also be characterized by relatively high inductances. In embodiments, for example, harness sections 24A-24C may be approximately three meters in length and be characterized by inductances in the range of 4 μH-5 μH. Embodiments of these types may include a fourth wiring harness section 24D approximately six meters in length and characterized by inductances in the range of 9 μH-10 μH. Other embodiments of engine system 8 include wiring harnesses such as 22 having different lengths and inductances (e.g., between 1 μH and 4 μH; between 4 μH and 9 μH; between 9 μH and 15 μH; or greater than 15 μH).

Because of the characteristic inductance of the wiring harness 22 and operating characteristics of the HCU 10, heater 18 and/or battery 20, energy effectively stored by the wiring harness 22 and the heater 18 when the HCU 10 is operating in its on state produce oscillating or cyclic and transient current flows through the HCU, heater and/or battery when the HCU is switched to its off state. As described below, HCU 10 is configured to accommodate these transient oscillating currents.

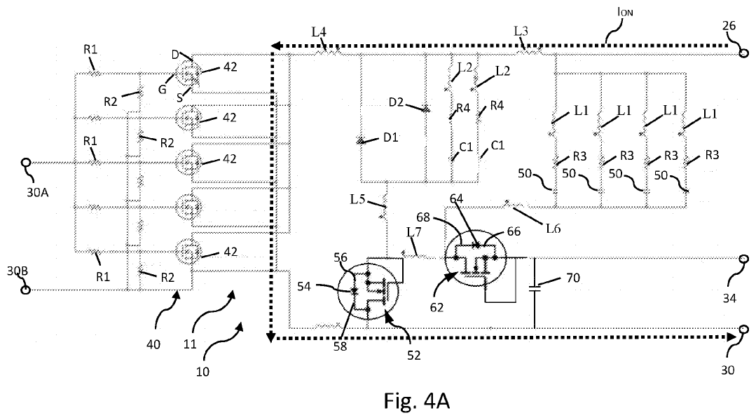

FIG. 3 is a schematic illustration of an output driver 11 of HCU 10 in accordance with embodiments. As shown, the output driver 11 includes a pair of control input terminals 30A and 30B that can be coupled to receive control signals from a source (such as the controller of HCU 10 (not shown) in response to signals from the ECU 16), the first or input supply terminal 26, the switched power output terminal 30, and the third or negative terminal 34. A switch 40, which in the illustrated embodiments is formed by a plurality of semiconductor MOSFETs 42, defines a first current flow path between the input supply terminal 26 to the switched power output terminal 30. MOSFETs 42 are connected in parallel in the illustrated embodiment, and each includes a gate coupled to the control input terminal 30A (e.g., through an associated resistor R1), a drain coupled to the input supply terminal 26, and a source coupled to the control input terminal 30B and the switched power output terminal 30. A resistor R2 couples the gate of each MOSFET 42 to the control input terminal 30B for biasing. As described in greater detail below, in response to control signals received at the control input terminals 30A and 30B, switch 40 (i.e., each of the MOSFETs 42) is switched between on and off states to electrically connect and disconnect, respectively, the input supply terminal 26 to the switched power output terminal 30, and thereby control the flow of current between the heater 18 and battery 20. When in the on state, output driver 11 of the HCU 10, via the switch 40, couples power to the heater 18 from the battery 20. When in the off state, output driver 11 of the HCU 10, via the switch 40, electrically disconnects the heater 18 from the battery 20. The functionality of the switch 40 may be provided by other components and/or circuit configurations in other embodiments.

A DC (direct current) link capacitor formed by one or more capacitors 50 (four are shown in the illustrated embodiment) are coupled in a path between the input power supply terminal 26 and the switched power output terminal 30. A first side or terminal of each of the capacitors 50 is coupled to the input supply terminal 26 and to a terminal of the switch 40. Capacitors 50 are connected in parallel in the illustrated embodiments.

A first MOSFET 52 configured as a diode 54 is connected in series with the capacitors 50, and the series-coupled capacitors and diode 54 define a second current flow path between the input supply terminal 26 and the switched power output terminal 30. The second current flow path defined by the series-coupled capacitors 50 and diode 54 is parallel to the first current flow path defined by the switch 40. An anode 56 of the diode 54 is coupled to a second side or terminal of each of the capacitors 50, and a cathode 58 of the diode 54 is coupled to the switched power output terminal 30. The diode 54 is thereby configured to enable current flow in a first direction through the diode from the capacitors 50 to the switched power output terminal 30, while preventing or blocking current flow in a second direction through the diode from the switched power output terminal to the capacitors.

A second MOSFET 62 configured as a diode 64 is connected in series with the capacitors 50, and the series-coupled capacitors and diode 64 define a third current flow path between the input supply terminal 26 and the negative terminal 34 of the HCU 10. An anode 66 of the diode 64 is coupled to the negative terminal 34 of the HCU 10, and a cathode 68 of the diode 62 is coupled to the second side or terminal of each of the capacitors 50. The diode 64 is thereby configured to enable current flow in a first direction through the diode from the negative terminal 34 to the capacitors 50, while preventing or blocking current flow in a second direction through the diode from the capacitors to the negative terminal.

The illustrated embodiments of output driver 11 shown in FIG. 3 includes additional components configured to characterize and/or enhance the functionality of the HCU described herein. Diodes D1 and D2 coupled between the input supply terminal 26 and the diodes 52 and 62 may be configured to provide reverse current protection. A capacitor 70 is connected between the negative terminal 34 and the switched power output terminal 30. In embodiments, the circuit shown in FIG. 3 is a simulated model of a physical implementation of the circuit, and resistor R3 and inductor L1 connected in series with each of the capacitors 50, the two series-connected sets of capacitors C1, resistors R4 and inductors L2 coupled in parallel with the diodes D1 and D2, and the inductors L3-L7 may characterize and/or compensate for certain printed circuit board (PCB) characteristics of an actual physical implementation, and may not be included in such an implementation. Other embodiments include other circuit components and configurations to provide the functionality of the HCU 10 and output driver 11 described herein.

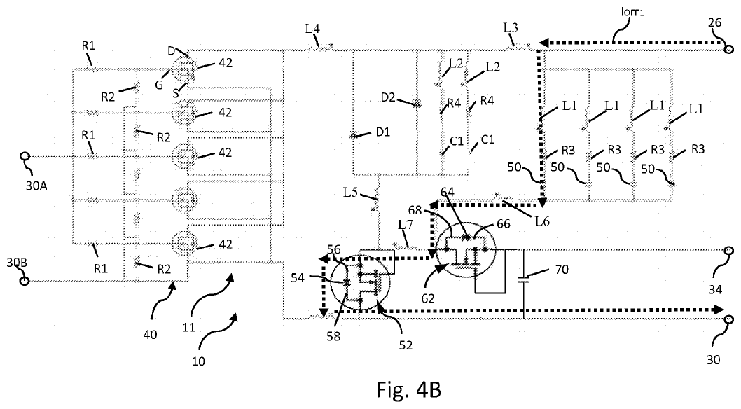

FIGS. 4A-4C illustrate the operation of the output driver 11 of HCU 10 in response to control signals received at the control input terminals 30A and 30B. In particular, FIG. 4A illustrates the current flow through the HCU 10 when the HCU is switched to and operating in its on state. FIGS. 4B and 4C illustrate the oscillating transient current flow through the HCU 10 when the HCU is switched to and operating in its off state.

As shown in FIG. 4A, HCU 10 operates in its on state in response to control signals that switch the switch 40 to an on state, thereby electrically coupling the input power supply terminal 26 to the switched power output terminal 30. In the illustrated embodiments, the control signals cause each of the parallel-connected MOSFETs 42 to switch to its on state, and thereby electrically couple the input supply terminal 26 to the switched power output terminal 30. FIG. 4A illustrates the current flow, ION, when the HCU 10 is operating in its on state. As shown, current flow ION is about a first path and in a first direction through the switch 40. When in the on state, the current flow ION is coupled between the battery 20 and heater 18 (e.g., via the wiring harness sections 24A, 24B and 24D shown in FIG. 2) to power the heater. The capacitors 50 will have no or relatively small charge when the HCU 10 is in its on state since the switch 40 provides a low resistance current flow path when the switch is in its on state.

As shown by FIGS. 4B and 4C, HCU 10 operates in its off state in response to control signals that switch the switch 40 to an off state, thereby preventing current flow through the switch 40. In the illustrated embodiments, the control signals cause each of the parallel-connected MOSFETs 42 to switch to its off state, and thereby electrically disconnect the input supply terminal 26 from the switched power output terminal 30 through the MOSFETs. As discussed above, however, while the HCU 10 was operating in its on state to power the heater 18, electrical energy was effectively being stored by the wiring harness 22 and heater 18, including one or more of wiring harness sections 24A, 24B and 24D. The stored energy in the wiring harness 22 is discharged through the HCU 10 by oscillating transient current signals during wiring harness discharge cycles after the HCU is switched off.

FIG. 4B illustrates the current flow I_{OFF1} about a second path during a first or capacitor charging portion of the wiring harness discharge cycle. As shown, because the capacitors 50 were uncharged when the HCU 10 is initially switched to it off state, and because of the configurations of the diodes 54 and 64, the current flow I_{OFF1} is from the input supply terminal 26 to the switched power output terminal 30, in a first direction through the capacitors 50. In particular, because of the configuration of the diode 64, the diode 64 blocks or prevents current from flowing in a direction from the input supply terminal 26 through the capacitors and to the negative terminal 34 of the HCU 10. The capacitors 50 are charged by the current flow I_{OFF1} during the first portion of the wiring harness discharge cycle. Although not labeled in FIG. 4B, during the first portion of the wiring harness discharge cycle energy stored in the heater 18 and portions of the wiring harness 22 is discharged by a current flow (not shown) from the negative terminal 34 to the switched power output terminal 30 through the diode 54.

Upon the completion of an initial first portion of the wiring harness discharge cycle, the current flow I_{OFF1} ends and capacitors 50 are charged. FIG. 4B illustrates the current flow I_{OFF2} about a second path during a second or capacitor discharging portion of the wiring harness discharge cycle. Because the capacitors 50 are in a charged state following the completion of the capacitor charging portion of the wiring harness discharge cycle, and because of the configurations of the diodes 54 and 64, the current flow I_{OFF2} is about a third path from the negative terminal 34 to the input supply terminal 26, through the diode 64 and the capacitors 50 in a second direction. The capacitors 50 are discharged by the current flow I_{OFF2} during the second portion of the wiring harness discharge cycle. Following the completion of an initial second portion of the wiring harness discharge cycle, the first and second portions of the wiring harness discharge cycle repeat in a cyclic manner until the energy that was stored by the wiring harness 22 while the HCU was in its on state is dissipated, or the HCU is again switched to its on state.

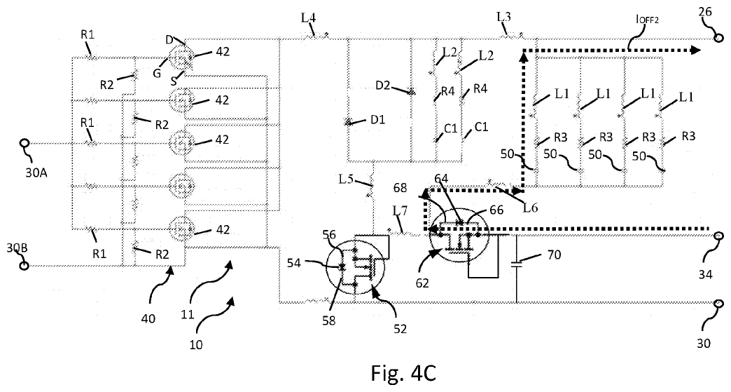

FIGS. 5A and 5B illustrate the instantaneous and RMS (root mean square) currents through the capacitors 50 of the HCU 10 shown in FIGS. 3 and 4A-4C, respectively, as the HCU periodically switches between its on and off states. As shown, there are relatively few and relatively low level wiring harness discharge cycles after each on state-to-off state transition of the HCU 10, resulting in relatively low RMS current (about 3.763 A). The size or number of capacitors 50 can be minimized or otherwise optimized by these results, and possible damage to circuit components such as the MOSFETs 52 and 62 can also be minimized. HCU 10 can thereby be optimized for functionality and efficiently manufactured.

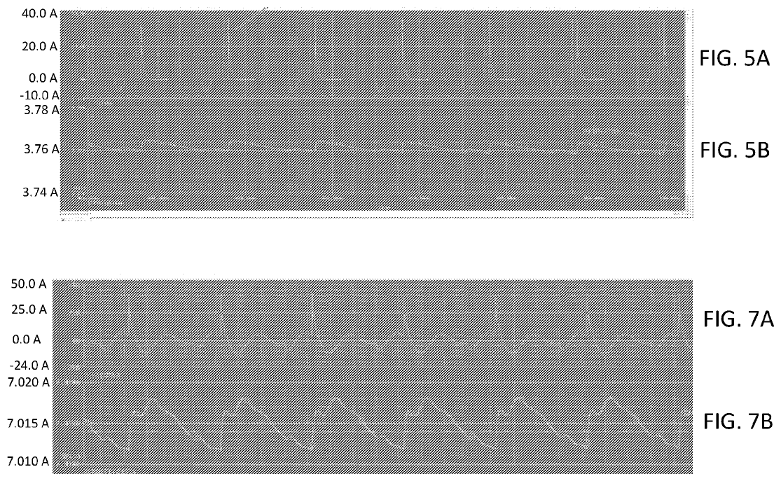

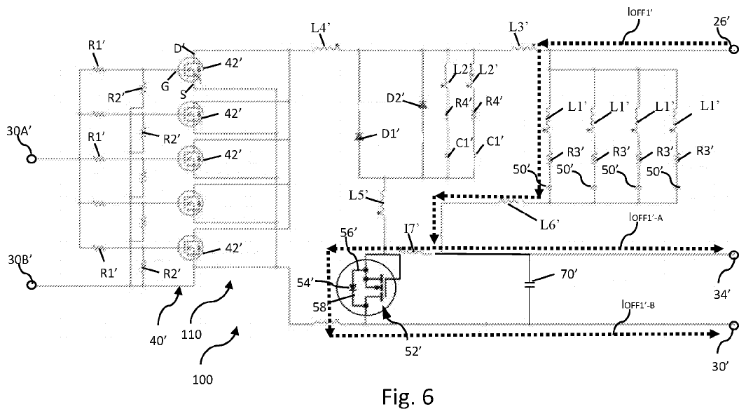

FIG. 6 is a diagrammatic schematic illustration of an output driver 110 of an HCU 100 that can be compared to the HCU 10 described above for purposes of example. HCU 100 is similar to HCU 10, but does not include the MOSFET 62/diode 64. In particular, the DC link capacitors 50′ of HCU 100 are substantially the same as those of capacitors 50 of HCU 10. Features of HCU 100 similar to those of HCU 10 are identified by similar reference numbers. HCU 100 has a negative terminal 34′ coupled to the second terminals of the diodes 50′ without a diode (e.g., no diode 64) configured to block current flow from the input supply terminal 26′ to the negative terminal 34′ during capacitor charging portions of the wiring harness discharge cycles. As shown in FIG. 6, during the capacitor charging portions of the wiring harness discharge cycles, the current I_{OFF1′}, after flowing from the input supply terminal 26′ in the first direction through the capacitors 50′, flows about path I_{OFF1′-A} to the negative terminal 34′, and about path I_{OFF1′-B} to the switched power output terminal 30′. FIGS. 7A and 7B illustrate the instantaneous and RMS currents through the capacitors 50′ of the HCU 100, respectively, under electrical and other operating conditions similar to those applied to HCU 10 and producing the outputs shown in FIGS. 5A and 5B (e.g., with the same battery, wiring harness and heater) as the HCU 100 periodically switches between its on and off states. As is evident from FIGS. 7A and 7B, the magnitude and number of current oscillations during the wiring harness discharge cycles are greater than those of HCU 10, and the RMS current is greater (about 7.016 A). HCU 10 provides enhanced performance over HCU 100.

It is to be understood that the above description is intended to be illustrative, and not restrictive. Many other embodiments will be apparent to those of skill in the art upon reading and understanding the above description. For example, it is contemplated that features described in association with one embodiment are optionally employed in addition or as an alternative to features described in or associated with another embodiment. The scope of the invention should, therefore, be determined with reference to the appended claims, along with the full scope of equivalents to which such claims are entitled.

1. A heater control unit for coupling an exhaust aftertreatment system heater to a power supply, comprising:
a switch responsive to a control signal and switchable between on and off states, the switch configured to control current flow about a first path between a first wiring harness section coupled to the power supply and a second wiring harness section coupled the heater, wherein the switch enables current flow about the first path when in the on state;
one or more capacitors;
a first diode coupled in series with the one or more capacitors, the series-coupled first diode and one or more capacitors configured to provide current flow about a second path between the first and second wiring harness sections, wherein when the switch is in the off state the first diode enables current flow about the second path through the one or more capacitors in a first direction, and blocks current flow about the second path through the one or more capacitors in a second direction opposite the first direction; and
a second diode coupled in series with the one or more capacitors, the series-connected second diode and one or more capacitors configured to provide current flow about a third path between the first wiring harness section and a third wiring harness section coupled to the power supply, wherein when the switch is in the off state the second diode enables current flow about the third path through the one or more capacitors in the second direction, and blocks current flow about the third path through the one or more capacitors in the first direction.

2. The heater control unit of claim 1 wherein one or both of the first and second diodes comprise a MOSFET configured as a diode.

3. The heater control unit of claim 1 wherein the one or more capacitors comprises a plurality of capacitors coupled in parallel.

4. The heater control unit of claim 1 wherein the switch comprises a plurality of discrete switches responsive to the control signal and coupled in parallel.

5. The heater control unit of claim 1 wherein the series-coupled first diode and one or more capacitors are coupled in parallel with the switch, and the first and second paths include parallel paths between the first and second wiring harness sections.

6. The heater control unit of claim 1 and further comprising a wiring harness to couple the heater control unit to the exhaust aftertreatment system heater and power supply, wherein the wiring harness includes:
the first wiring harness section to couple the switch (e.g., a first terminal of the switch) and the one or more capacitors (e.g., a terminal of the capacitors opposite the capacitors from the first diode) to a first polarity (e.g., positive) terminal of the power supply;
the second wiring harness section to couple the switch (e.g., a second terminal of the switch) and the first diode (e.g., a terminal of the diode opposite the diode from the capacitors) to a first terminal (e.g., positive) of the heater; and
the third section to couple the second diode (e.g., a terminal of the diode opposite the diode from the capacitors) to a second polarity (e.g., negative) terminal of the power supply.

7. The heater control unit of claim 6 wherein each of one or more of the first, second and third wiring harness sections is defined by an inductance (e.g., between 1 μH, and 4 μH; between 4 μH, and 9 μH; or greater than 9 μH).

8. The heater control unit and harness of claim 6 and further including the exhaust aftertreatment heater and the power supply coupled to the heater control unit by the first, second and third wiring harness sections.

9. The combination of claim 8, wherein the wiring harness further includes a fourth wiring harness section to couple the second polarity terminal of the power supply (e.g., negative) to a second terminal (e.g., negative) of the heater.

10. The combination of claim 9 wherein the fourth wiring harness section is defined by an inductance (e.g., between 1 μH, and 4 μH; between 4 μH, and 9 μH; or greater than 9 μH).

11. A heater control unit for coupling an exhaust aftertreatment system heater to a power supply, comprising:
a control input configured to receive a control signal;
a first polarity supply terminal configured to be coupled to a first polarity terminal of the power supply;
a switched power output terminal configured to be coupled to a first terminal of the heater;
a second polarity supply terminal configured to be coupled to a second polarity terminal of the power supply;
a switch coupled to the control input and switchable between on and off states, wherein the switch is configured to control current flow about a first path between the first polarity supply terminal and the switched power output terminal, and enables current flow about the first path when in the on state;
one or more capacitors;
a first diode including an anode and a cathode coupled in series with the one or more capacitors, the series-coupled first diode and one or more capacitors defining a second path including the one or more capacitors between the first polarity supply terminal and the switched power output terminal, wherein when the switch is in the off state the first diode enables current flow about the second path in a first direction through the one or more capacitors, and blocks current flow about the second path in a second direction opposite the first direction through the one or more capacitors;
a second diode including an anode and a cathode coupled in series with the one or more capacitors, the series-coupled second diode and one or more capacitors defining a third path including the one or more capacitors between the first polarity supply terminal and the second polarity supply terminal, wherein when the switch is in the off state the second diode enables current flow about the third path in the second direction through the one or more capacitors, and blocks current flow about the third path in the first direction through the one or more capacitors.

12. The heater control unit of claim 11 wherein:
the first polarity supply terminal is a positive supply terminal configured to be coupled to a positive terminal of the power supply;
the second polarity supply terminal is a negative supply terminal configured to be coupled to a negative terminal of the power supply;
the one or more capacitors each include a first terminal coupled to the positive supply terminal, and a second terminal;
the first diode includes an anode coupled to the second terminal of each of the one or more capacitors and a cathode coupled to the switched power output terminal;
the second diode includes an anode coupled to the negative supply terminal and a cathode coupled to second terminal of each of the one or more capacitors.

13. The heater control unit of claim 11 wherein one or both of the first and second diodes comprise a MOSFET configured as a diode.

14. The heater control unit of claim 11 wherein the one or more capacitors comprise a plurality of capacitors coupled in parallel.

15. The heater control unit of claim 11 wherein the switch comprises a plurality of semiconductor switches coupled in parallel.

16. The heater control unit of claim 11 wherein the series-coupled first diode and one or more capacitors are coupled in parallel with the switch, and the first and second paths include parallel paths between the first polarity supply terminal and the switched power output terminal.

17. The heater control unit of claim 11 and further comprising a wiring harness to couple the heater control unit to the exhaust aftertreatment system heater and power supply, wherein the wiring harness includes:
a first wiring harness section to couple the first polarity supply terminal to a first polarity terminal of the power supply;
a second wiring harness section to couple the switched power output terminal to a first terminal of the heater; and
a third section to couple the second polarity supply terminal to a second polarity terminal of the power supply.

18. The heater control unit and harness of claim 17 wherein each of one or more of the first, second and third wiring harness sections is defined by an inductance (e.g., between 1 μH, and 4μ; between 4 μH, and 9μ; or greater than 9 μH).

19. The heater control unit and harness of claim 17 and further including the exhaust aftertreatment heater and the power supply coupled to the heater control unit by the first, second and third wiring harness sections.

20. The combination of claim 19 wherein the wiring harness further includes a fourth wiring harness section to couple the second polarity terminal of the power supply to a second terminal of the heater.

21. (canceled)
